(19) United States
(12) Patent Application Publication
(10) Pub. No.: US 2013/0326097 A1
(43) Pub. Date: Dec. 5, 2013

(54) SEMICONDUCTOR DEVICE

(71) Applicants: Kenichi Shimizu, Chiyoda-ku (JP); Toshihiro Morita, Chiyoda-ku (JP); Yasuhiro Ami, Chiyoda-ku (JP)

(72) Inventors: Kenichi Shimizu, Chiyoda-ku (JP); Toshihiro Morita, Chiyoda-ku (JP); Yasuhiro Ami, Chiyoda-ku (JP)

(73) Assignee: RENESAS ELECTRONICS CORPORATION, Kawasaki-shi, Kanagawa (JP)

(21) Appl. No.: 13/984,428

(22) PCT Filed: Feb. 17, 2012
(86) PCT No.: PCT/JP2012/053761

§ 371 Date: Aug. 8, 2013

(30) Foreign Application Priority Data
Mar. 17, 2011 (JP) 2011-059318

(51) Int. Cl. G06F 13/40

(52) U.S. Cl. CPC G06F 13/4063
USPC 710/104

(57) ABSTRACT

A semiconductor device capable of implementing system configurations corresponding to various PCIe topologies is provided. A RAM stores one or more configuration registers that define function information of a PCIe device. A Link control unit decodes a request received from a PCIe host and outputs a decoded result to a CPU. The CPU reads a corresponding configuration register from the RAM based on the decoded result received from the Link control unit, and generates a response to the request and causes the Link control unit to transmit the response. Thus, system configurations corresponding to various PCIe topologies can be implemented.

### TECHNICAL FIELD

The present invention relates to a technique for controlling an I/O (Input/Output) serial interface, and relates to, for example, a semiconductor device capable of implementing system configurations corresponding to various PCI (Peripheral Component Interconnect) Express (hereinafter referred to as “PCIe”) topologies.

### BACKGROUND ART

As data processing apparatuses such as personal computers have recently become more advanced in performance and multifunctionality, various types of interface circuits are being mounted thereon. PCIe can be mentioned as one example of such an interface.

PCIe is a serial interface that has been developed as a next-generation interface to overcome the insufficient transfer rate of a conventional PCI bus, and has realized full compatibility with the PCI bus at the software level. PCIe, therefore, can run on any OS (Operating System) in which the conventional PCI bus can run, without particularly requiring new support.

Examples of elements configuring a PCIe system include a root complex, an endpoint, a switch, a bridge, and the like, which are connected with one another to thereby implement various topologies. In connection with this, the following techniques have been disclosed.

Japanese Patent Laying-Open No. 11-288400 (Patent Document 1) discloses a PCI bridge device with a reduced amount of circuitry. The PCI bridge device spuriously implements configuration space of a device that is connected to a secondary-side pseudo-PCI bus. A secondary-side pseudo-PCI interface unit thus acquires information (functional numbers shown to a primary-side PCI bus) of the above-mentioned device, immediately after resetting. A decoding unit associates the information of the device with IDSEL for output to the secondary-side pseudo-PCI bus. When a primary-side PCI interface unit then detects a configuration cycle, it relays the cycle with the secondary-side pseudo-PCI interface unit, and the decoding unit replaces some bits of the information of the device.

Japanese Patent Laying-Open No. 11-238030 (Patent Document 2) discloses a customized PCI-PCI bridge that is supported reliably by existing BIOS (Basic Input/Output System) and provided with a DMA (Direct Memory Access) controller and an LSI (Large Scale Integrated Circuit) core on the same chip. The customized PCI-PCI bridge uses the type “00” header, and identifies a secondary PCI device using function numbers to enable a configuration. The PCI-PCI bridge switches between memory maps at the time of and after startup, in order to support a VGA device together with a processing core and a PCI agent. The PCI-PCI bridge adjusts bus drive such that two PCI buses are not driven simultaneously.

Japanese Patent Laying-Open No. 2002-024161 (Patent Document 3) discloses a PCI agent integrated circuit in which the number of PCI agents to be incorporated is not restricted, subsequent addition and replacement of a PCI agent can be easily made, the entire circuit scale can be reduced, and a layout design can be made to reduce a propagation delay in a signal line, and also discloses a communication method for such a PCI agent integrated circuit. The PCI agent integrated circuit is composed of a single PCI bus control unit for common use among a plurality of PCI agents, a function control unit for each of the PCI agents, and an internal common bus that is connected among the PCI agents for common use. This facilitates changing the configuration of the PCI agents or changing the design when a new PCI agent is added.

### CITATION LIST

### Patent Document

PTD 1: Japanese Patent Laying-Open No. 11-288400
PTD 2: Japanese Patent Laying-Open No. 11-238030
PTD 3: Japanese Patent Laying-Open No. 2002-024161

### SUMMARY OF INVENTION

### Technical Problem

In the case of adding a PCIe device function to a system design having a PCIe-PCI bridge, it is necessary to align a plurality of LSIs on a product substrate, or increase the number of IPs (Intellectual Properties) incorporated in an LSI.

For example, when a topology in which the PCIe-PCI bridge and a PCIe endpoint are aligned downstream of a PCIe switch is configured, at least three types of LSIs or IPs are required.

Thus, the realization of such a topology with a plurality of LSIs poses problems such as an increased substrate area and increased costs of components. The realization of such a topology with a plurality of IPs incorporated in an LSI also poses problems such as an increased number of gates and an increased package size. In either case, these problems lead to an increased development cost as well.

Other objects and novel features will become apparent from the descriptions of the present specification and the attached drawings.

### Solution to Problem

In accordance with one embodiment, there is provided a semiconductor device that implements a device configuring a PCIe topology. A RAM stores one or more configuration registers that define function information of a PCIe device. A Link control unit decodes a request received from a PCIe host and outputs a decoded result to a CPU (Central Processing Unit). The CPU reads a corresponding configuration register from the RAM based on a decoded result received from the Link control unit, and generates a response to the request and causes the Link control unit to transmit the response.

### Advantageous Effects of Invention

In accordance with the foregoing embodiment, the CPU reads the corresponding configuration register from the RAM in accordance with the decoded result received from the Link control unit, and generates the response to the request and causes the Link control unit to transmit the response. This allows system configurations corresponding to various PCIe topologies to be implemented.

### BRIEF DESCRIPTION OF DRAWINGS

FIG. 1 is a diagram showing one example configuring a topology in which a PCIe-PCI bridge and a PCIe endpoint are aligned downstream of a PCIe switch.

FIG. 2 is a block diagram showing an exemplary configuration of a semiconductor device according to a first embodiment.

FIG. 3 is a flowchart for illustrating operation of PCIe device hardware and a software sequencer when the PCIe device hardware has received a request packet.

FIG. 4 is a block diagram for illustrating a more detailed configuration of the semiconductor device according to the first embodiment.

FIG. 5 is a diagram showing one example where a PCIe-PCI bridge configuration is implemented by the semiconductor device according to the first embodiment.

FIG. 6 is a diagram showing one example where a configuration of a PCIe switch and a PCIe-PCI bridge is implemented by the semiconductor device according to the first embodiment.

FIG. 7 is a diagram for illustrating a read operation of a configuration register when each of the topologies shown in FIGS. 5 and 6 is implemented by the semiconductor device according to the first embodiment shown in FIG. 4.

FIG. 8 is a diagram for illustrating a read operation of a configuration register for a device connected to a PCI bus when each of the topologies shown in FIGS. 5 and 6 is implemented by the semiconductor device according to the first embodiment shown in FIG. 4.

FIG. 9 is a diagram for illustrating a memory read operation for the device connected to the PCI bus when each of the topologies shown in FIGS. 5 and 6 is implemented by the semiconductor device according to the first embodiment shown in FIG. 4.

FIG. 10 is a block diagram showing an exemplary configuration of a semiconductor device according to a second embodiment.

FIG. 11 is a diagram showing one example where a configuration of a PCIe endpoint (general-purpose device) is implemented by the semiconductor device according to the second embodiment.

FIG. 12 is a diagram showing another example where a configuration of a PCIe endpoint (general-purpose device) is implemented by the semiconductor device according to the second embodiment.

FIG. 13 is a diagram showing one example where a configuration of a topology having a PCIe switch and two PCIe endpoints is implemented by the semiconductor device according to the second embodiment.

FIG. 14 is a diagram showing one example where a configuration of a topology having three PCIe switches and five PCIe endpoints is implemented by the semiconductor device according to the second embodiment.

FIG. 15 is a diagram for illustrating a write operation of a configuration register when each of the topologies shown in FIGS. 11 to 14 is implemented by the semiconductor device according to the second embodiment.

FIG. 16 is a diagram for illustrating a memory write operation to a device connected to a general-purpose device when each of the topologies shown in FIGS. 11 to 14 is implemented by the semiconductor device according to the second embodiment.

### DESCRIPTION OF EMBODIMENTS

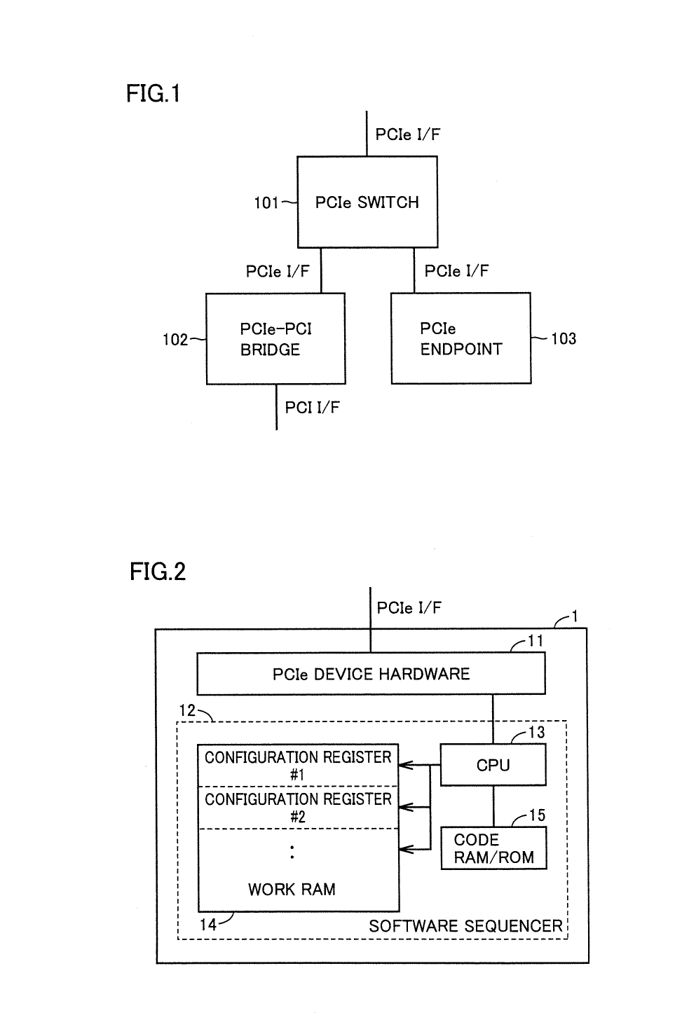

FIG. 1 is a diagram showing one example configuring a topology in which a PCIe-PCI bridge and a PCIe endpoint are aligned downstream of a PCIe switch. As shown in FIG. 1, a downstream side of PCIe switch 101 is connected to PCIe bridge 102 and PCIe endpoint 103 via a PCIe I/F (Interface).

A downstream of PCIe-PCI bridge 102 is connected to a PCI endpoint and the like via PCI I/F. When such a topology is configured, the use of at least three types of LSIs or IPs is necessary, which causes problems such as an increased development cost as described above.

### First Embodiment

FIG. 2 is a block diagram showing an exemplary configuration of a semiconductor device according to a first embodiment. Semiconductor device 1 includes PCIe device hardware 11 and a software sequencer 12. Software sequencer 12 includes a CPU 13, a work RAM (Random Access Memory) 14, and a code RAM/ROM (Read Only Memory) 15. Semiconductor device 1 communicates with a PCIe host via a PCIe I/F.

PCIe device hardware 11 is connected to the PCIe I/F, and mainly performs control of a physical layer and a data link layer. CPU 13 mainly performs control of a transaction layer by executing a program stored in code RAM/ROM 15. Work RAM 14 stores configuration registers, details of which will be described later.

The transaction layer mainly generates and decodes a transaction layer packet (TLP). TLP is composed of a command such as a read or a write, an address, data, or the like. The transaction layer also performs flow control between connected devices.

Credit-based flow control is performed in PCIe. The credit-based flow control is a scheme in which a receiving side notifies in advance a transmitting side of a buffer size that can be received, and conveys to the transmitting side every time empty space is available in the buffer. The transmitting side sums sizes of received packets, and when it is notified of empty space in the buffer from the receiving side, the transmitting side subtracts an amount of the empty space from a sum size of received packets. This allows transfer of packets without exceeding the buffer size of the receiving side.

The transaction layer supports three address spaces, which are memory space, I/O space, and configuration space.

In the case of controlling a PCIe (PCI) device, the control is performed by operating configuration registers of a PCIe bus (PCI bus). For details, reference may be made to the PCI specification, for example.

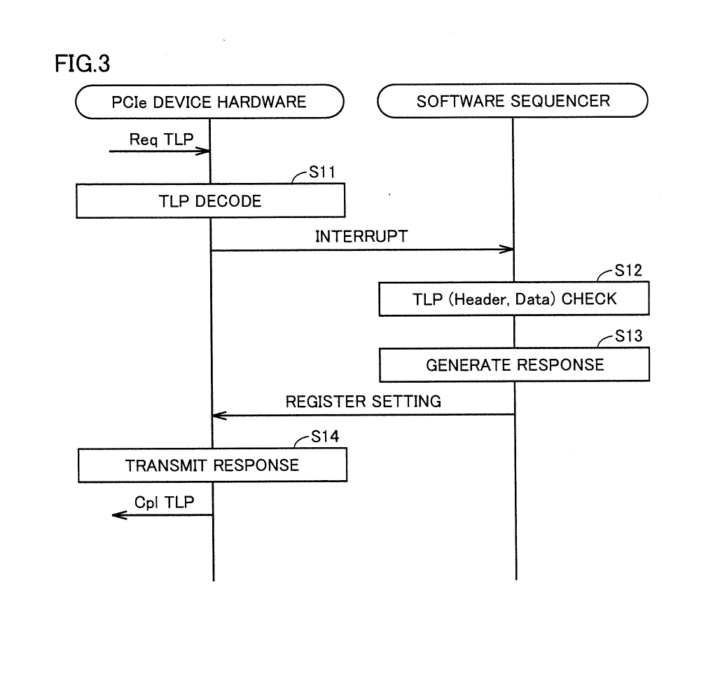

FIG. 3 is a flowchart for illustrating operation of PCIe device hardware 11 and a software sequencer 12 when PCIe device hardware 11 has received a request packet.

Initially, when PCIe device hardware 11 receives a request packet (Req TLP) from the PCIe host via the PCIe I/F, it decodes the TLP and determines what kind of request the TLP is, and then outputs an interrupt request in accordance with the request to CPU 13 of software sequencer 12 (S11). It is noted that the request packet includes a memory request, which is a request for reading/writing from/to the memory, an I/O request, which is a request for reading/writing from/to the I/O, a configuration request for reading/writing from/to the configuration space, etc.

When CPU 13 within software sequencer 12 receives the interrupt request from PCIe device hardware 11, it checks a header and data of the TLP (S12), generates a response to the request packet, and sets the generation of the response in a control register for notification (S13). Here, reference is made as appropriate to the value of a configuration register stored in work RAM 14.

When PCIe device hardware 11 receives the notification of the generation of the response from software sequencer 12, it transmits a response (Cpl TLP: Completion) via the PCIe I/F (S14). Here, in the case of reading, the response also includes the data.

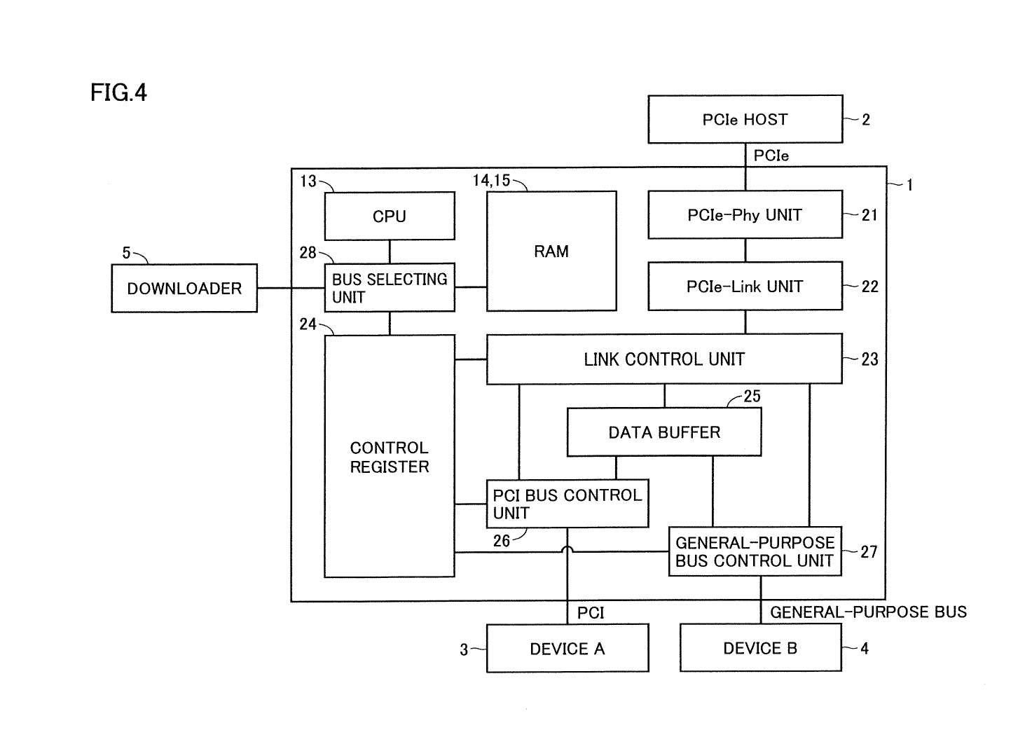

FIG. 4 is a block diagram for illustrating a more detailed configuration of the semiconductor device according to the first embodiment. Semiconductor device 1 includes CPU 13, RAMs 14, 15, a PCIe-Phy unit 21, a PCIe-Link unit 22, a Link control unit 23, a control register 24, a data buffer 25, a PCI bus control unit 26, a general-purpose bus control unit 27, and a bus selecting unit 28.

PCIe-Phy unit 21, which is connected to PCIe host 2 via the PCIe I/F, has the function of the physical layer of PCIe. PCIe-Link unit 22 has the function of the data link layer of PCIe.

Link control unit 23 decodes the received TLP (request packet) output from PCIe-Link unit 22 and determines what kind of request the TLP is, and then outputs an interrupt request to CPU 13. Link control unit 23 transmits the response (completion) corresponding to the request packet to PCIe host 2 via PCIe-Link unit 22 and PCIe-Phy unit 21.

Control register 24 includes a group of registers provided for the control of semiconductor device 1 itself, and is distinguished from the configuration registers.

Data buffer 25 temporarily stores data that is transmitted to a device A (3) or a device B (4) via the PCI bus or the general-purpose bus, and data received from device A (3) or device B (4) via the PCI bus or the general-purpose bus.

When the request packet is a memory read from or a memory write to device A (3) which is connected to PCI bus, PCI bus control unit 26 transmits and receives data to and from device A (3).

When the request packet is a memory read from or a memory write to device B (4) which is connected to the general-purpose bus, general-purpose bus control unit 27 transmits and receives data to and from device B (4).

Bus selecting unit 28 is connected to a downloader 5, CPU 13, RAMs 14, 15, and control register 24, and switches the bus. For example, when downloader 5 downloads a program executed on CPU 13 into RAM 15, bus selecting unit 28 switches the bus such that a processing code output from downloader 5 is written to RAM 15.

Moreover, when CPU 13 executes the program stored in RAM 15, bus selecting unit 28 switches the bus such that CPU 13 can fetch the processing code stored in RAM 15. Furthermore, when CPU 13 accesses control register 24, bus selecting unit 28 switches the bus such that CPU 13 can read/write from/to control register 24.

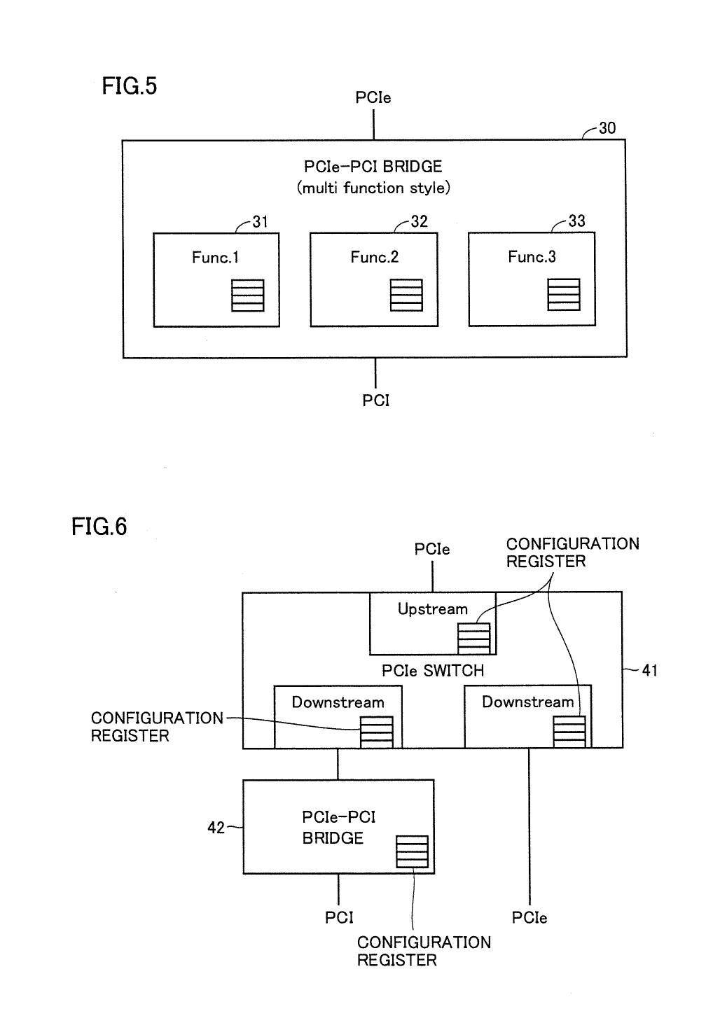

FIGS. 5 and 6 are diagrams showing examples of topologies implemented by the semiconductor device according to the first embodiment. FIG. 5 is a diagram showing one example where a PCIe-PCI bridge configuration is implemented by semiconductor device 1 according to the first embodiment. PCIe-PCI bridge 30 has three device functions (Func. 1 to Func. 3) 31 to 33, and three configuration registers corresponding to respective device functions 31 to 33 are disposed in RAM 14 shown in each of FIGS. 2 and 4. Each of the functions of device functions 31 to 33 is implemented by CPU 13 executing the program stored in RAM 15.

FIG. 6 is a diagram showing one example where a configuration of a PCIe switch and a PCIe-PCI bridge is implemented by semiconductor device 1 according to the first embodiment. PCIe switch 41 has an upstream port (Upstream) and two downstream ports (Downstream), and three configuration registers corresponding to the respective ports are disposed in RAM 14 shown in each of FIGS. 2 and 4. PCIe-PCI bridge 42 has one configuration register, which is disposed in RAM 14 shown in each of FIGS. 2 and 4.

PCIe host 2 searches for a PCIe topology by reading a configuration register corresponding to each device function at system startup. When a device function number for each of the device functions hits the device function number in a configuration register defined in RAM 14, CPU 13 instructs Link control unit 23 to return a completion that means the presence of the device function, thereby causing PCIe host 2 to recognize the device function.

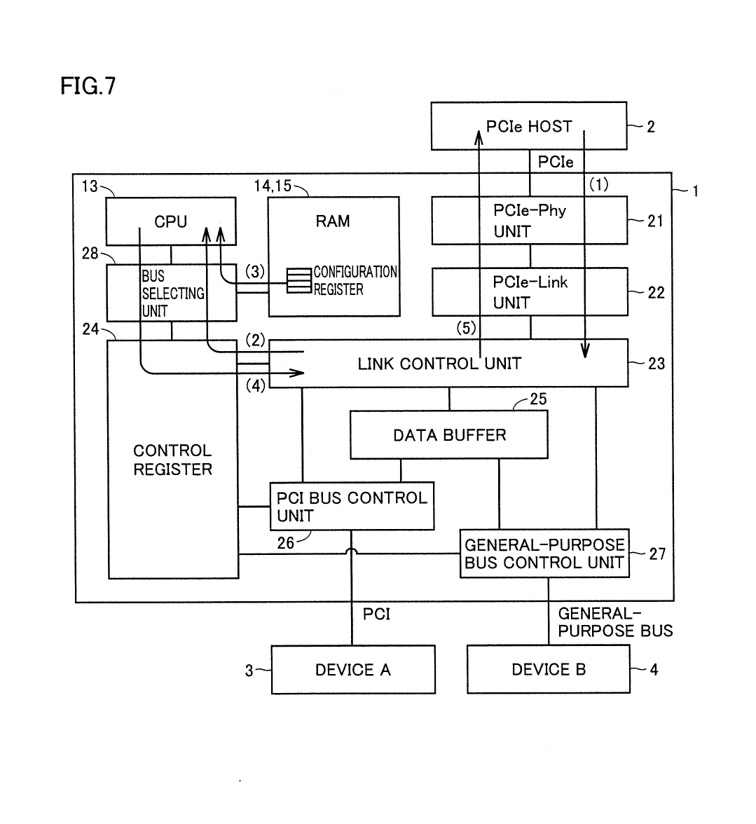

FIG. 7 is a diagram for illustrating a read operation of a configuration register when each of the topologies shown in FIGS. 5 and 6 is implemented by semiconductor device 1 according to the first embodiment shown in FIG. 4.

Initially, when Link control unit 23 receives a request packet from PCIe host 2 via PCIe-Phy unit 21 and PCIe-Link unit 22 ((1) in FIG. 7), it decodes the TPL. When Link control unit 23 detects that the TPL is a configuration read, Link control unit 23 notifies CPU 13 that the configuration read has been received ((2) in FIG. 7).

Link control unit 23 may issue this notification by outputting an interrupt request to CPU 13 as described above, or by writing to control register 24 the reception of the configuration read, which is then polled by CPU 13.

When CPU 13 receives the notification from Link control unit 23, it reads contents of a corresponding configuration register from RAM 14 ((3) in FIG. 7), and sets the data in Link control unit 23 ((4) in FIG. 7). Link control unit 23 then transmits a completion, as well as the contents of the configuration register, to PCIe host 2 via PCIe-Link unit 22 and PCIe-Phy unit 21.

For example, when the topology shown in FIG. 5 is configured with semiconductor device 1 according to this embodiment, configuration registers corresponding to device functions 31 to 33 are stored in RAM 14. CPU 13 reads from RAM 14 contents of a configuration register corresponding to a device function requested by PCIe host 2, and sets the contents in Link control unit 23.

When the topology shown in FIG. 6 is configured with semiconductor device 1 according to this embodiment, RAM 14 stores three configuration registers of PCIe switch 41, which are an upstream port (Upstream) and two downstream ports (Downstream), and one configuration register of PCIe-PCI bridge 42. CPU 13 reads from RAM 14 contents of a configuration register corresponding to a device requested by PCIe host 2, and sets the contents in Link control unit 23.

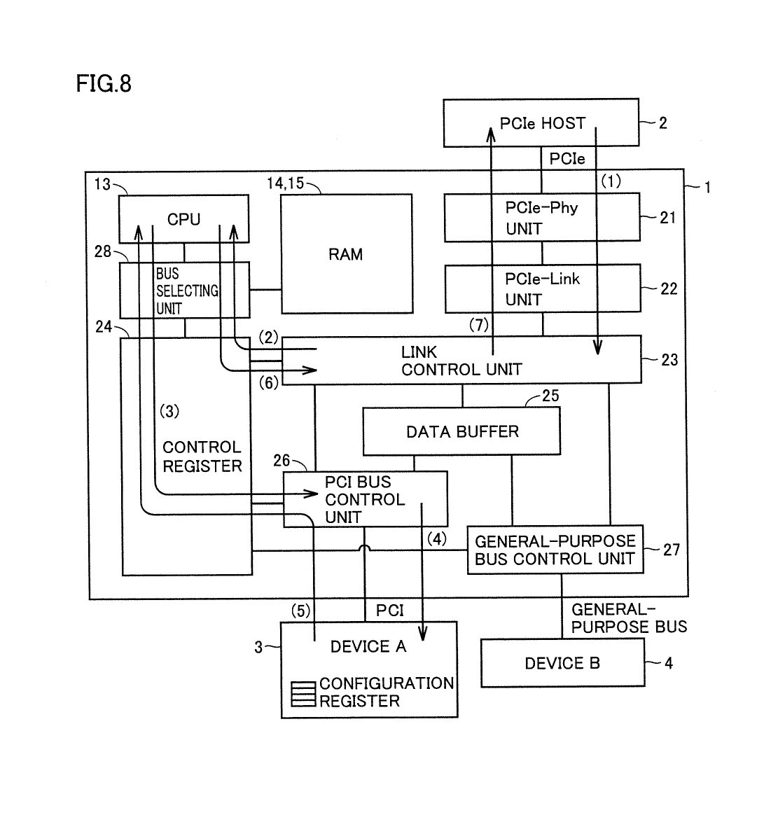

FIG. 8 is a diagram for illustrating a read operation of a configuration register from a device connected to a PCI bus when each of the topologies shown in FIGS. 5 and 6 is implemented by semiconductor device 1 according to the first embodiment shown in FIG. 4.

Initially, when Link control unit 23 receives a request packet from PCIe host 2 via PCIe-Phy unit 21 and PCIe-Link unit 22 ((1) in FIG. 8), it decodes the TPL. When Link control unit 23 then detects that the TPL is a configuration read for device A (3), Link control unit 23 notifies CPU 13 that the configuration read has been received ((2) in FIG. 8).

When CPU 13 receives the notification from Link control unit 23, it requests a PCI configuration read cycle to PCI bus control unit 26 ((3) in FIG. 8). PCI bus control unit 26 then issues a configuration read to device A (3) ((4) in FIG. 8).

When device A (3) receives the configuration read from PCI bus control unit 26, it transmits contents of the configuration register to PCI bus control unit 26. PCI bus control unit 26 then notifies CPU 13 of the read data received from device A (3) ((5) in FIG. 8).

Next, CPU 13 sets the contents of the configuration register received from PCI bus control unit 26 in Link control unit 23 ((6) in FIG. 8). Link control unit 23 then transmits a completion, as well as the contents of the configuration register, to PCIe host 2 via PCIe-Link unit 22 and PCIe-Phy unit 21.

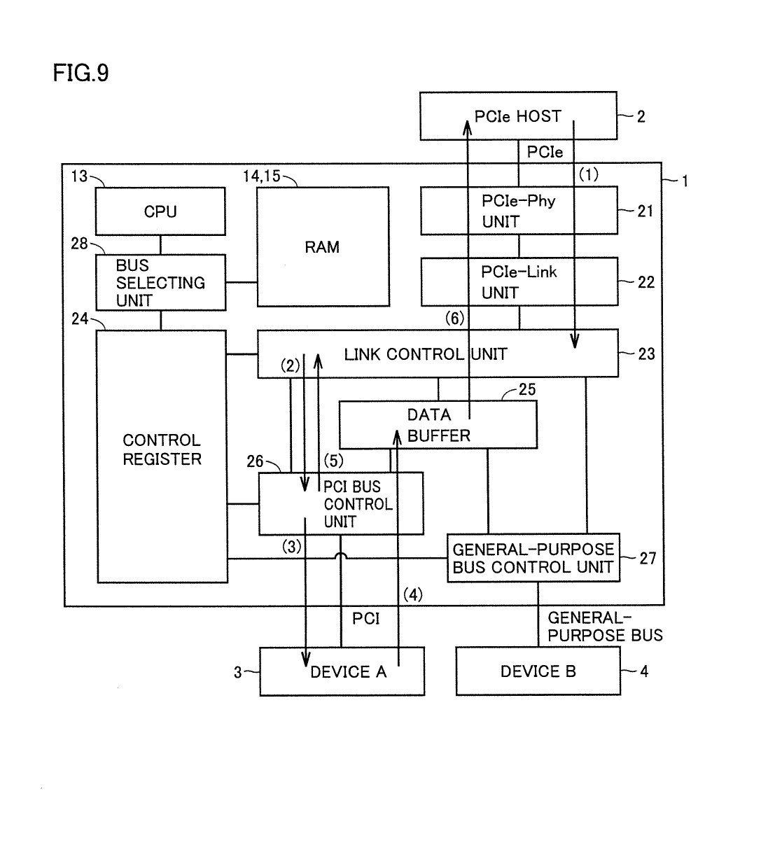

FIG. 9 is a diagram for illustrating a memory read operation from the device connected to the PCI bus when each of the topologies shown in FIGS. 5 and 6 is implemented by semiconductor device 1 according to the first embodiment shown in FIG. 4.

Initially, when Link control unit 23 receives a request packet from PCIe host 2 via PCIe-Phy unit 21 and PCIe-Link unit 22 ((1) in FIG. 9), it decodes the TPL. When Link control unit 23 detects that the TPL is a memory read from device A (3), Link control unit 23 notifies PCI bus control unit 26 that the memory read has been received ((2) in FIG. 9).

When PCI bus control unit 26 receives the notification from Link control unit 23, it issues the memory read to device A (3) ((3) in FIG. 9). When PCI bus control unit 26 then receives read data from device A (3), it causes the data to be sequentially stored in data buffer 25 ((4) in FIG. 9).

When PCI bus control unit 26 then completes the reception of the read data, it notifies Link control unit 23 of the completion of the read data ((5) in FIG. 9). When Link control unit 23 receives the notification from PCI bus control unit 26, it transmits a completion to PCIe host 2 via PCIe-Link unit 22 and PCIe-Phy unit 21, and sequentially transmits the read data for storage in data buffer 25.

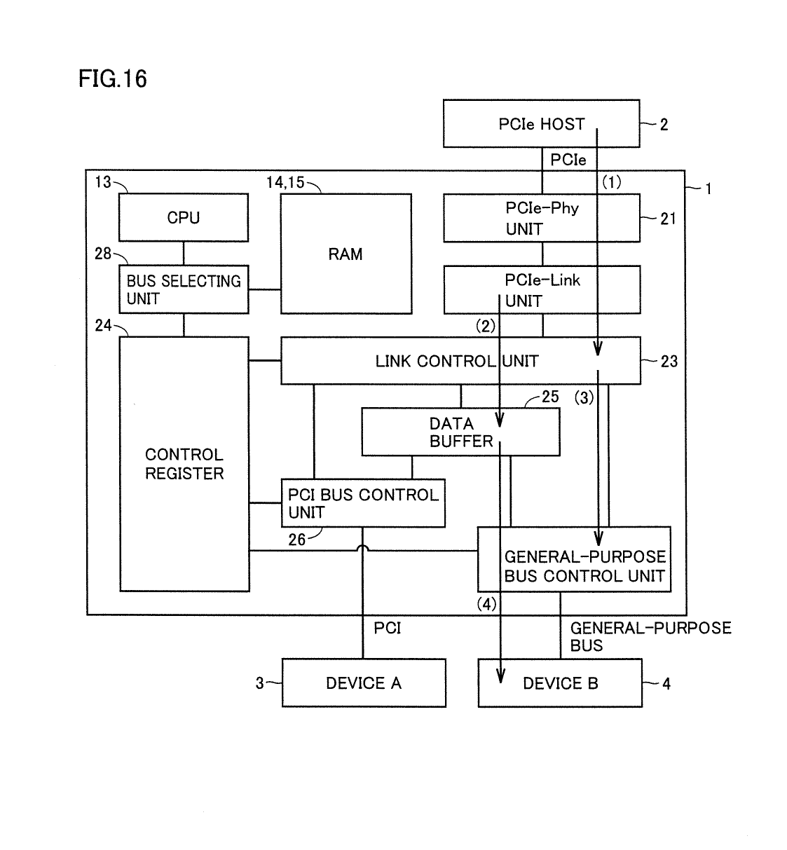

It is noted that a memory write to device A (3) is performed by an operation similar to that shown in FIG. 16 that will be described below, and the operation differs only in that data is written to device A (3) via PCI bus control unit 26.

As described above, in the semiconductor device according to this embodiment, the configuration registers of the PCIe device configuring a PCIe topology are stored in RAM 14, and upon reception of a request from PCIe host 2, a response is transmitted to PCIe host 2 with reference to the configuration registers stored in RAM 14. This has enabled the realization of system configurations corresponding to various PCIe topologies.

Moreover, when a topology with any combination of a plurality of PCIe devices such as a PCIe-PCI bridge, a PCIe switch, an endpoint, and the like is configured with the semiconductor device according to this embodiment, the number of hardware devices for controlling the physical layer, the data link layer, and the like among these PCIe devices can be reduced. This has enabled a reduction in substrate area and/or component costs, or a reduction in the number of gates and/or package size.

Furthermore, even after shipping of the semiconductor device, changes can be made to the PCIe topologies and device functions, thus allowing any trouble that is found during debugging to be corrected, and/or allowing a change to be made to the specification as requested by a client, for example.

Moreover, in the semiconductor device according to this embodiment, when a desired topology is implemented, the memory read operation from the device connected to the PCI bus is performed by bypassing CPU 13. While the memory transfer time can be shortened in this way, the method of memory transfer is not limited to the above, and memory transfer may also be performed via CPU 13.

### Second Embodiment

In a semiconductor device according to a second embodiment, configuration registers corresponding to general-purpose devices connected to a general-purpose bus are stored in RAM 14, and the configuration registers are used to control the general-purpose devices as devices spuriously connected to a PCIe topology. It is noted that the configuration of the semiconductor device according to the second embodiment is similar to that of the semiconductor device according to the first embodiment shown in FIG. 4. Detailed description of the same configuration and functions will not therefore be repeated.

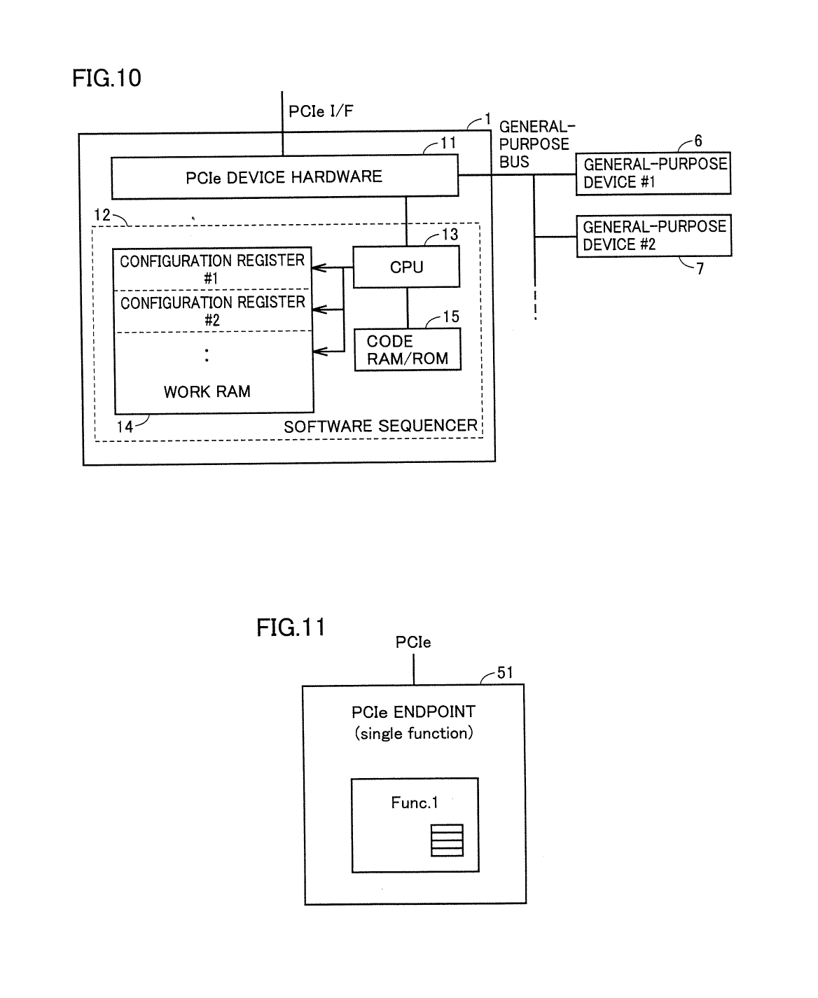

FIG. 10 is a block diagram showing an exemplary configuration of the semiconductor device according to the second embodiment. The semiconductor device according to the second embodiment differs from the configuration example of the semiconductor device according to the first embodiment shown in FIG. 2 in that PCIe device hardware 11 is connected to general-purpose devices 6 and 7 via the general-purpose bus. Detailed description of the same configuration and functions will not therefore be repeated. The general-purpose bus herein refers to a bus other than the PCIe bus and PCI bus described above.

FIGS. 11 to 14 are diagrams showing examples of topologies implemented by the semiconductor device according to the second embodiment. FIG. 11 is a diagram showing one example where a configuration of a PCIe endpoint (general-purpose device) 51 is implemented by semiconductor device 1 according to the second embodiment. This endpoint has a single device function (Func. 1) only, and a corresponding configuration register is disposed in RAM 14 shown in FIGS. 2 and 4.

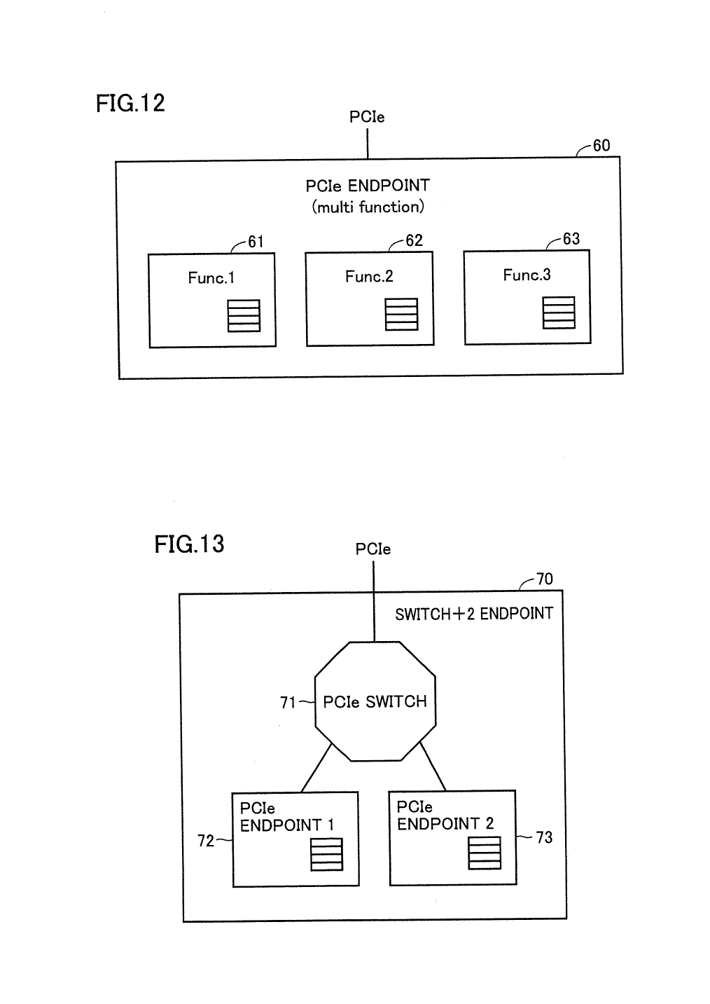

FIG. 12 is a diagram showing one example where a configuration of a PCIe endpoint (general-purpose device) 60 is implemented by semiconductor device 1 according to the second embodiment. This endpoint has three device functions (Func. 1 to Func. 3) 61 to 63, and configuration registers corresponding to respective three device functions 61 to 63 are disposed in RAM 14 shown in FIGS. 2 and 4.

FIG. 13 is a diagram showing one example where a configuration of a topology 70 having a PCIe switch 71 and two PCIe endpoints 72 and 73 is implemented by semiconductor device 1 according to the second embodiment. Configuration registers corresponding to PCIe switch 71 and two PCIe endpoints 72 and 73 are disposed in RAM 14 shown in FIGS. 2 and 4. In this case, the total number of configuration registers is five.

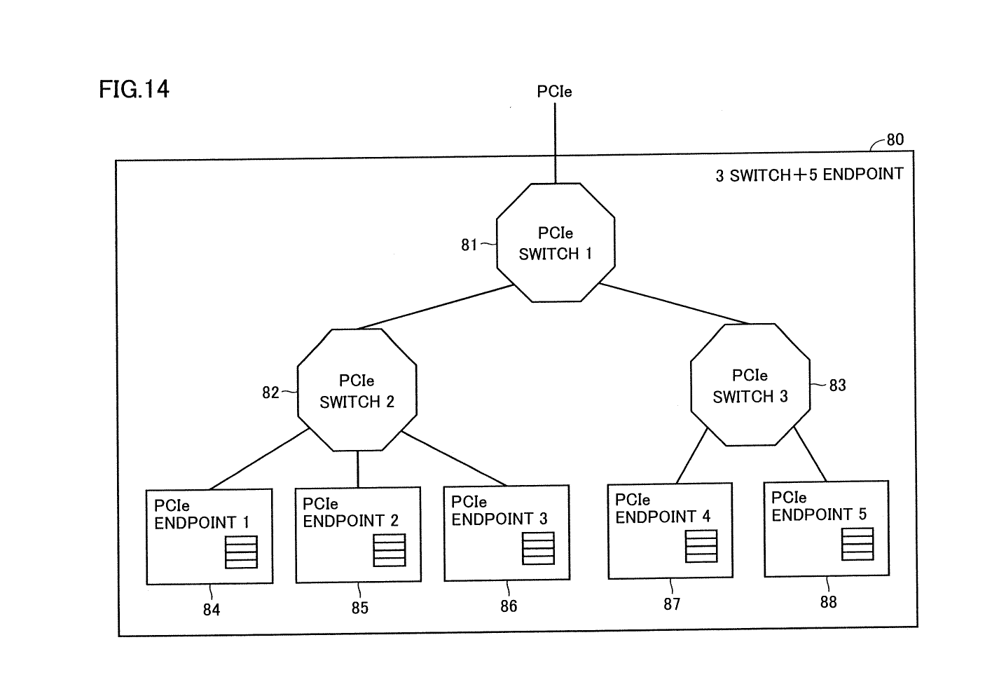

FIG. 14 is a diagram showing one example where a configuration of a topology 80 having three PCIe switches and five PCIe endpoints is implemented by semiconductor device 1 according to the second embodiment. Configuration registers corresponding to three PCIe switches 1 to 3 (81 to 83) and five PCIe endpoints 84 to 88 are disposed in RAM 14 shown in FIGS. 2 and 4. In this case, the total number of configuration registers is 14.

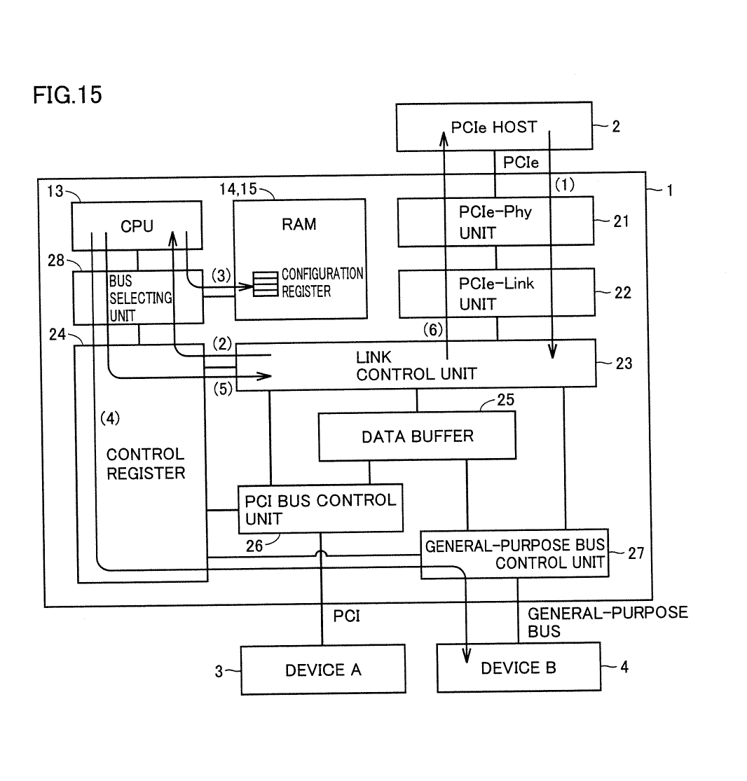

FIG. 15 is a diagram for illustrating a write operation of a configuration register when each of the topologies shown in FIGS. 11 to 14 is implemented by semiconductor device 1 according to the second embodiment.

Initially, when Link control unit 23 receives a request packet from PCIe host 2 via PCIe-Phy unit 21 and PCIe-Link unit 22 ((1) in FIG. 15), it decodes the TPL. When Link control unit 23 then detects that the TPL is a configuration write, Link control unit 23 notifies CPU 13 that the configuration write has been received ((2) in FIG. 15). Here, Link control unit 23 also receives write data from PCIe host 2 and transfers the data to CPU 13.

When CPU 13 receives the notification from Link control unit 23, it writes contents of a configuration register received from Link control unit 23 to RAM 14 ((3) in FIG. 15), and, if necessary, CPU 13 notifies device B (4) of a change in operation settings via general-purpose bus control unit 27 ((4) in FIG. 15).

CPU 13 also sets the response status in Link control unit 23 ((5) in FIG. 15). Link control unit 23 then transmits a completion to PCIe host 2 via PCIe-Link unit 22 and PCIe-Phy unit 21 ((6) in FIG. 15).

It is noted that an operation of a configuration read for general-purpose device B (4) is similar to the read operation of the configuration register shown in FIG. 7, and thus, detailed description thereof will not be repeated.

FIG. 16 is a diagram for illustrating an operation of memory write to a device connected to a general-purpose bus when each of the topologies shown in FIGS. 11 to 14 is implemented by semiconductor device 1 according to the second embodiment.

Initially, when Link control unit 23 receives a request packet from PCIe host 2 via PCIe-Phy unit 21 and PCIe-Link unit 22 ((1) in FIG. 16), it decodes the TPL. When Link control unit 23 then detects that the TPL is a memory write to device B (4), it causes write data received from PCIe host 2 to be stored in data buffer 25 ((2) in FIG. 16).

Next, Link control unit 23 notifies general-purpose bus control unit 27 that the memory write has been received ((3) in FIG. 16). General-purpose bus control unit 27 then issues the memory write to device B (4), and sequentially transmits write data for storage to data buffer 25 to device B (4) ((4) in FIG. 16).

It is noted that a memory read from device B (4) connected to the general-purpose bus is performed by an operation similar to that shown in FIG. 9 described above, and the operation differs only in that data is read from device B (4) via general-purpose bus control unit 27.

As described above, in the semiconductor device according to this embodiment, the configuration registers of the general-purpose devices connected to the general-purpose bus are stored in RAM 14, and contents of any of these configuration registers are returned to the configuration read from PCIe host 2. Therefore, in the semiconductor device according to this embodiment, in addition to the effects described in the first embodiment, the general-purpose registers can be spuriously connected to the PCIe topology.

While the invention made by the present inventors has been specifically described above based on the embodiments, the present invention is by no means limited to the foregoing embodiments, and can be modified in various manners without departing from the gist of the invention.

### REFERENCE SIGNS LIST

1: semiconductor device; 2: PCIe host; 3, 4: device; 5: downloader; 6, 7: general-purpose device; 11: PCIe device hardware; 12: software sequencer; 13: CPU; 14: work RAM; 15: code RAM/ROM; 21: PCIe-Phy unit; 22: PCIe-Link unit; 23: Link control unit; 24: control register; 25: data buffer; 26: PCI bus control unit; 27: general-purpose bus control unit; 28: bus selecting unit.

1. A semiconductor device that implements a device configuring a topology of a serial interface bus comprising:
a processor;
a storage unit configured to store data to which reference is made by said processor; and
a serial interface bus control unit configured to control a physical layer and a data link layer of said serial interface bus,
said storage unit storing one or more configuration registers that define function information of said device,
said serial interface bus control unit decoding a request received from a host and outputting a decoded result to said processor, and
said processor reading a corresponding configuration register from said storage unit based on the decoded result received from said serial interface bus control unit, generating a response to said request and causing said serial interface bus control unit to transmit the response, setting a content of said configuration register in said serial interface bus control unit, and changing control of devices connected to said serial interface bus control unit based on said content of said configuration register set in said serial interface bus control unit.

2. The semiconductor device according to claim 1, wherein
said serial interface bus is a PCIe bus.

3. The semiconductor device according to claim 1, wherein
said processor changes a device that is to be implemented by said semiconductor device, by changing a total number of said one or more configuration registers stored in said storage unit and a function of each of said configuration registers.

4. The semiconductor device according to claim 1, wherein
said semiconductor device further includes a PCI bus control unit configured to control transmission and reception of data to and from a device connected to a PCI bus, and
when the decoded result decoded by said serial interface bus control unit is a request concerning control of said device connected to said PCI bus, said PCI bus control unit implements a function of a bridge by transmitting and receiving data to and from said device connected to said PCI bus.

5. The semiconductor device according to claim 4, wherein
said storage unit stores a configuration register for each of an upstream port and a downstream port, and
when the decoded result decoded by said serial interface bus control unit is a configuration read for said upstream port or said downstream port, said processor reads a corresponding configuration register from said storage unit and cause said serial interface bus control unit to transmit a content of said configuration register, thereby implementing functions of said bridge and a switch.

6. The semiconductor device according to claim 1, wherein
said semiconductor device further includes a general-purpose bus control unit that controls transmission and reception of data to and from a general-purpose device connected to a general-purpose bus,
said storage unit stores one or more configuration registers corresponding to said general-purpose device, and
when the decoded result decoded by said serial interface bus control unit is a configuration read for said general-purpose device, said processor reads from said storage unit a configuration register corresponding to said general-purpose device and cause said serial interface bus control unit to transmit a content of said configuration register, and when the decoded result decoded by said serial interface bus control unit is a request concerning control of said general-purpose device, said general-purpose bus control unit transmits and receives data to and from said general-purpose device, thereby controlling said general-purpose device as a device spuriously connected to the topology of said serial interface bus.

7. The semiconductor device according to claim 1, wherein
said serial interface bus control unit outputs to said processor an interrupt request corresponding to the decoded result of the request received from said host, and
said processor makes reference to a corresponding configuration register in response to the interrupt request received from said serial interface bus control unit.

8. The semiconductor device according to claim 1, wherein
said serial interface bus control unit writes the decoded result of the request received from said host to a register, and
said processor determines the request received from said serial interface bus control unit by polling the decoded result written in said register, and makes reference to a corresponding configuration register.

9. A semiconductor device that implements a device configuring a topology of a serial interface bus comprising:
a processor;
a storage unit configured to store data to which reference is made by said processor;
a serial interface bus control unit configured to control a physical layer and a data link layer of said serial interface bus; and
a general-purpose bus control unit that controls transmission and reception of data to and from a general-purpose device connected to a general-purpose bus, and
said storage unit storing one or more configuration registers that define function information of said device,
said serial interface bus control unit decoding a request received from a host and outputting a decoded result to said processor, and
said processor reading a corresponding configuration register from said storage unit based on the decoded result received from said serial interface bus control unit, and generating a response to said request and causing said serial interface bus control unit to transmit the response,
said storage unit stores one or more configuration registers corresponding to said general-purpose device, and
when the decoded result decoded by said serial interface bus control unit is a configuration read for said general-purpose device, said processor reads from said storage unit a configuration register corresponding to said general-purpose device and cause said serial interface bus control unit to transmit a content of said configuration register, and when the decoded result decoded by said serial interface bus control unit is a request concerning control of said general-purpose device, said general-purpose bus control unit transmits and receives data to and from said general-purpose device, thereby controlling said general-purpose device as a device spuriously connected to the topology of said serial interface bus.

10. The semiconductor device according to claim 2, wherein
said processor changes a device that is to be implemented by said semiconductor device, by changing a total number of said one or more configuration registers stored in said storage unit and a function of each of said configuration registers.

11. The semiconductor device according to claim 2, wherein
said semiconductor device further includes a PCI bus control unit configured to control transmission and reception of data to and from a device connected to a PCI bus, and
when the decoded result decoded by said serial interface bus control unit is a request concerning control of said device connected to said PCI bus, said PCI bus control unit implements a function of a bridge by transmitting and receiving data to and from said device connected to said PCI bus.

12. The semiconductor device according to claim 2, wherein
said semiconductor device further includes a general-purpose bus control unit that controls transmission and reception of data to and from a general-purpose device connected to a general-purpose bus,
said storage unit stores one or more configuration registers corresponding to said general-purpose device, and
when the decoded result decoded by said serial interface bus control unit is a configuration read for said general-purpose device, said processor reads from said storage unit a configuration register corresponding to said general-purpose device and cause said serial interface bus control unit to transmit contents of said configuration register, and when the decoded result decoded by said serial interface bus control unit is a request concerning control of said general-purpose device, said general-purpose bus control unit transmits and receives data to and from said general-purpose device, thereby controlling said general-purpose device as a device spuriously connected to the topology of said serial interface bus.
